(19) United States
(12) Patent Application Publication
(10) Pub. No.: US 2008/0306832 A1
(43) Pub. Date: Dec. 11, 2008

(54) Broadcasting data purchasing system and method thereof

(75) Inventors: Wei-Hao Syu, Taipei (TW); Jeng-Chun Chen, Taipei (TW); Yi-Hsiu Cheng, Taipei (TW)

Correspondence Address: BACON & THOMAS, PLLC, 625 SLATERS LANE, FOURTH FLOOR, ALEXANDRIA, VA, 22314-1176, US

(73) Assignee: Arcadyan Technology Corporation, Hsinchu (TW)

(21) Appl. No.: 11/808,293

(22) Filed: Jun. 8, 2007

(51) Int. Cl. G06Q 30/00

(52) U.S. Cl. 705/26; 707/104.1

(57) ABSTRACT

A broadcasting data purchasing system includes an internet radio station, a media receiver and an online shopping server. The internet radio station provides broadcasting data. The media receiver receives, plays the broadcasting data and judges whether the broadcasting data includes metadata, which includes first audio information relevant to the broadcasting data. The media receiver responds with an operation event to output the first audio information when the broadcasting data includes the metadata. The online shopping server includes a goods database. The online shopping server receives the first audio information, searches for goods data from the goods database according to the first audio information, and stores the goods data.

### BACKGROUND OF THE INVENTION

1. Field of the Invention

The invention relates in general to a broadcasting data purchasing system, and more particularly to a broadcasting data purchasing system capable of responding with broadcasting data played by a media receiver to provide a purchasing service of the broadcasting data.

2. Description of the Related Art

In the age of the rapidly developing consumer electronic products, a media receiver capable of integrating, playing and managing various video-audio requirements at home has been available. The media receiver is for receiving multimedia video-audio data, such as a network broadcast or an analog broadcast, and thus driving a corresponding user interface device, such as a sounder or a personal computer, to perform the corresponding multimedia video-audio entertainment.

When a user is listening to the network or analog broadcast and hears the broadcasting data he or she wants to purchase, he or she cannot purchase the broadcasting data from a music shop until relevant information, such as the author, the concert program or the album name, is found from the broadcasting data. However, a lot of time-consuming and complicated searching operations have to be performed to search for the relevant information from the broadcasting data. Thus, it is an important subject to provide a convenient broadcasting data purchasing channel for the user.

### SUMMARY OF THE INVENTION

The invention is directed to a broadcasting data purchasing system and a method thereof capable of effectively improving the drawback that the conventional media receiver cannot effectively provide the convenient broadcasting data purchasing channel. Thus the system and the method of the invention substantially have the advantage of providing the convenient broadcasting data purchasing channel for the user.

According to a first aspect of the present invention, a broadcasting data purchasing system comprising an internet radio station, a media receiver and an online shopping server is provided. The internet radio station provides broadcasting data. The media receiver receives and plays the broadcasting data, and judges whether the broadcasting data includes metadata. The metadata includes first audio information relevant to the broadcasting data, and the media receiver responds with an operation event to output the first audio information when the broadcasting data includes the metadata. The online shopping server includes a goods database, receives the first audio information, searches for goods data from the goods database according to the first audio information, and stores the goods data.

According to a second aspect of the present invention, a broadcasting data purchasing method is provided. The method includes the steps of: receiving and playing broadcasting data; judging whether the broadcasting data includes metadata, wherein the metadata includes first audio information relevant to the broadcasting data; responding with an operation event to output the first audio information if the broadcasting data includes the metadata; and searching for goods data from a goods database according to the first audio information and storing the goods data.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a broadcasting data purchasing system according to a first embodiment of the invention.

FIG. 2 is a detailed block diagram showing a media receiver of FIG.

FIG. 3 is a flow chart showing a broadcasting data purchasing method according to the embodiment of the invention.

FIG. 4 is a block diagram showing a broadcasting data purchasing system according to a second embodiment of the invention.

FIG. 5 is a detailed block diagram showing a media receiver of FIG. 4.

FIG. 6 is a flow chart showing a broadcasting data purchasing method according to the embodiment of the invention.

FIG. 7 is a block diagram showing another broadcasting data purchasing system according to the embodiment of the invention.

### DETAILED DESCRIPTION OF THE INVENTION

The broadcasting data purchasing system of this embodiment has a media receiver capable of responding with broadcasting data of a network broadcast or an analog broadcast to search for corresponding audio information so as to search for music goods data relevant to the broadcasting data directly according to the audio information.

### First Embodiment

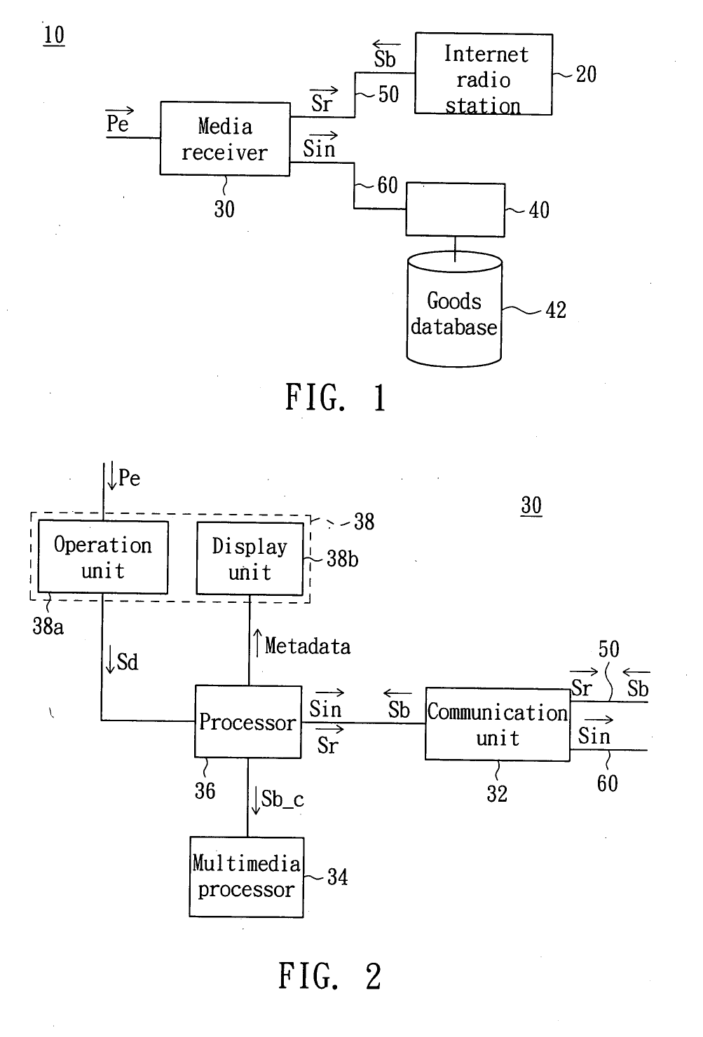

FIG. 1 is a block diagram showing a broadcasting data purchasing system 10 according to a first embodiment of the invention. Referring to FIG. 1, the broadcasting data purchasing system 10 comprises a internet radio station 20, a media receiver 30 and a online shopping server 40, wherein the media receiver 30 is connected to the internet radio station 20 and the online shopping server 40 respectively through communication links 50 and 60 (Internet).

The media receiver 30 provides request data Sr to the internet radio station 20 to drive the internet radio station 20 to provide broadcasting data Sb through the communication link 50. The media receiver 30 may receive and play the broadcasting data Sb from the internet radio station 20. The broadcasting data Sb is an internet packet. The broadcasting data Sb comprises a broadcasting content data Sb_c and a metadata M. The media receiver 30 can receive and play the broadcasting content data Sb_c. The media receiver 30 can judge whether the broadcasting data Sb includes the metadata M, such as audio information Sin, which is relevant to the broadcasting content data Sb_c and includes an author, a concert program and an album name, for example.

The media receiver 30 responds with a purchasing operation event Pe, issued by a user, to output the audio information Sin. The online shopping server 40 includes a goods database 42, for example. The online shopping server 40 receives the audio information Sin and searches for corresponding goods data from the goods database 42 according to the audio information Sin, and the online shopping server 40 stores the goods data. Thus, the broadcasting data purchasing system 10 of this embodiment can effectively respond with the metadata M of the broadcasting data Sb to search for and store the corresponding goods data.

FIG. 2 is a detailed block diagram showing a media receiver of FIG. 1. Referring to FIG. 2, the media receiver 30 includes a communication unit 32, a multimedia processor 34, a processor 36 and a user interface unit 38. The communication unit 32, the multimedia processor 34 and the user interface unit 38 are connected to the processor 36.

The communication unit 32 is connected to the internet radio station 20 and the online shopping server 40 through the communication links 50 and 60, receives the broadcasting data Sb, outputs the request data Sr, and outputs the audio information Sin. The communication unit 32 further outputs the broadcasting data Sb to the processor 36. The processor 36 generates the request data Sr and judges whether the broadcasting data Sb includes the metadata M. When the broadcasting data Sb includes the metadata M, the processor 36 generates the audio information Sin according to the metadata M, and the processor 36 responds with a driving signal Sd to output the audio information Sin.

The multimedia processor 34 receives and plays the broadcasting data Sb outputted from the processor 36. The user interface unit 38 receives and displays the audio information Sin, and the user interface unit 38 further responds with the purchasing operation event Pe to generate driving data Sd for driving the processor 36.

In this embodiment, the user interface unit 38 includes, for example, an operation unit 38a and a display unit 38b. The operation unit 38a responds with the purchasing operation event Pe to generate the driving data Sd. The display unit 38b receives and displays the audio information Sin generated by the processor. Thus, the user may obtain the audio information Sin relevant to the broadcasting data Sb through the display unit 38b.

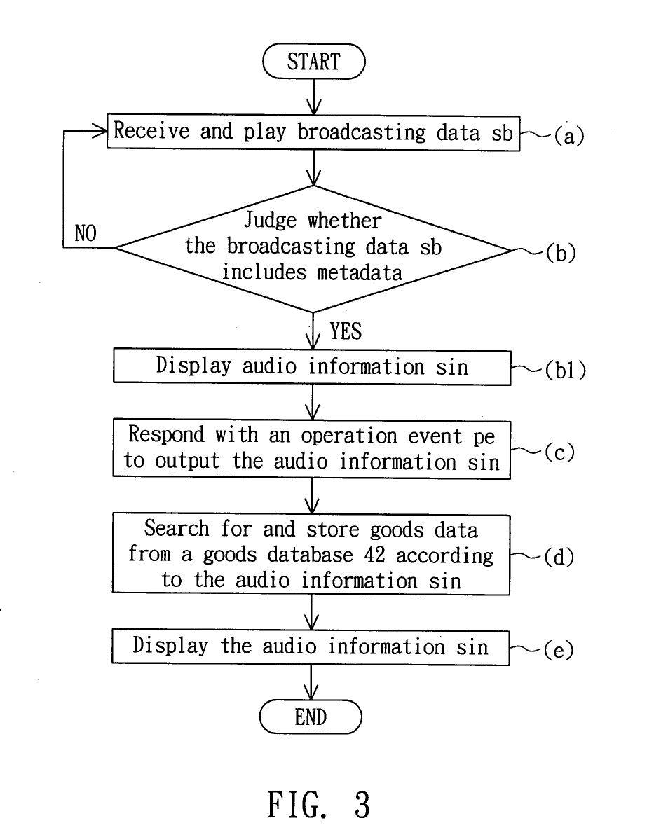

FIG. 3 is a flow chart showing a broadcasting data purchasing method according to the embodiment of the invention. Referring to FIG. 3, the method includes the following steps. First, as shown in the step (a), the communication unit 32 of the media receiver 30 receives the broadcasting data Sb_c outputted from the internet radio station 20, and the multimedia processor 34 of the media receiver 30 plays the broadcasting data Sb. Next, as shown in the step (b), the processor 36 judges whether the broadcasting data Sb includes the metadata M. When the broadcasting data Sb includes the metadata M, in the step (b1), the media receiver 30 displays the audio information Sin in the metadata (audio information Sin: the author, the concert program or the album name) on the display unit 38b. User can see the audio information Sin on the display unit 38b.

the step (c), in which the operation unit 38a responds with the purchasing operation event Pe to generate the driving signal Sd for driving the processor 36 to output the audio information Sin, is performed. The step (d), the multimedia processor 34 receives the audio information Sin and searches for and stores the goods data from the goods database 42 according to the audio information Sin. Thereafter, as shown in the step (e), the media receiver 30′ displays the audio information Sin in the display unit 38b.

The operation unit 38a of this embodiment may be, for example, a user input interface, such as a button, a touch pad or a control panel, capable of detecting an operation of the user. The communication link 60 and communication link 50 of this embodiment is a communication link using the hypertext transfer protocol (HTTP). The communication unit 32 is a communication unit corresponding to a network client, and the online shopping server 40 also has a communication unit corresponding to a network server. The internet radio station 20 of this embodiment may be, for example, a network radio station. The request data Sr includes, for example, a network address of the network radio station.

The online shopping server 40 of this embodiment may further include, for example, user account storage spaces (not shown) so that the goods data may be stored to one of the user account storage spaces corresponding to the media receiver 30. Thus, the user may log in the corresponding user account storage space of the online shopping server 40 to access the goods data subsequently, and then purchase the broadcasting data through the broadcasting data purchasing platform provided by the online shopping server 40.

The broadcasting data purchasing system and the method thereof according to this embodiment can find the audio information and the media receiver of the corresponding goods data according to the metadata of the network broadcasting data. Thus, the broadcasting data purchasing system and the method thereof according to this embodiment can effectively improve the drawback of the conventional media receiver, which cannot effectively provide the convenient broadcasting data purchasing channel. Thus, the invention substantially has the advantage of providing the convenient broadcasting data purchasing channel for the user.

### Second Embodiment

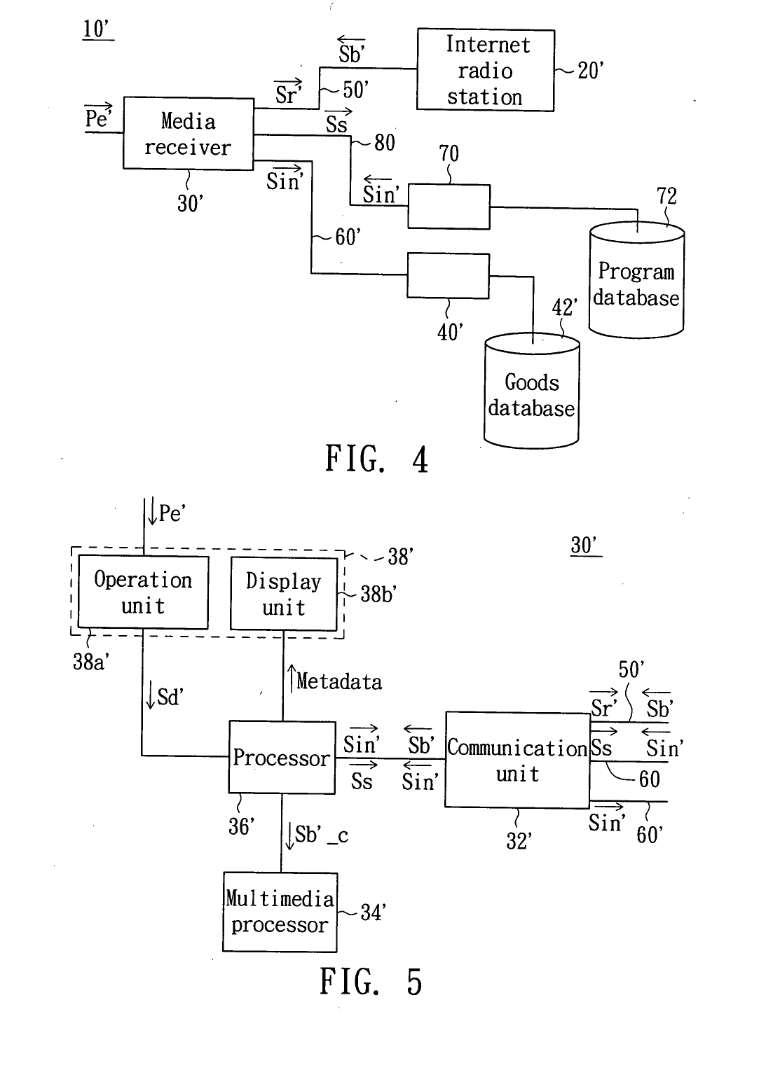

FIG. 4 is a block diagram showing a broadcasting data purchasing system 10′ according to a second embodiment of the invention. FIG. 5 is a detailed block diagram showing a media receiver of FIG. 4. The difference between the broadcasting data purchasing system 10′ of this embodiment and the broadcasting data purchasing system 10 of the first embodiment is that broadcasting data Sb′ outputted from a internet radio station 20′ does not include the metadata M. The broadcasting data Sb′ includes, for example, only the broadcasting content data. The media receiver 30 can receive and play the broadcasting content data. The broadcasting data purchasing system 10′ of this embodiment is connected to a program data server 70 and finds out audio information Sin′ corresponding to the broadcasting data Sb′. The internet radio station 20′ may be a network broadcasting unit, and the broadcasting data Sb′ may be network broadcasting data, for example.

The difference between a media receiver 30′ and the media receiver 30 of the first embodiment is that a communication unit 32′ is further connected to the program data server 70 through a communication link 80 and that a processor 36′ generates station data Ss relevant to the internet radio station 20′. When the processor 36′ judges that the broadcasting data Sb′ does not include the metadata M, the processor 36′ outputs the station data Ss to the program data server 70.

The program data server 70 includes a program database 72 for storing many internet radio stations and the program data thereof. The program data server 70 finds out the audio information Sin′ corresponding to the broadcasting data Sb′ from the program database 72 according to the station data Ss and outputs the audio information Sin′. The program database 72 of this embodiment stores, for example, many network addresses of many radio stations and the program data thereof, and the program data server 70 acquires the audio information Sin′ from the program data according to the current time. The processor 36′ acquires the network address of the internet radio station 20‘from the request data Sr’ and the network address serves as the station data ss, for example.

Thereafter, the communication unit 32′ receives the audio information Sin′ outputted from the program data server 70 through the communication link 80 and inputs the audio information Sin′ to the processor 36′, which outputs the audio information Sin′ to an online shopping server 40′ to find out the corresponding goods data.

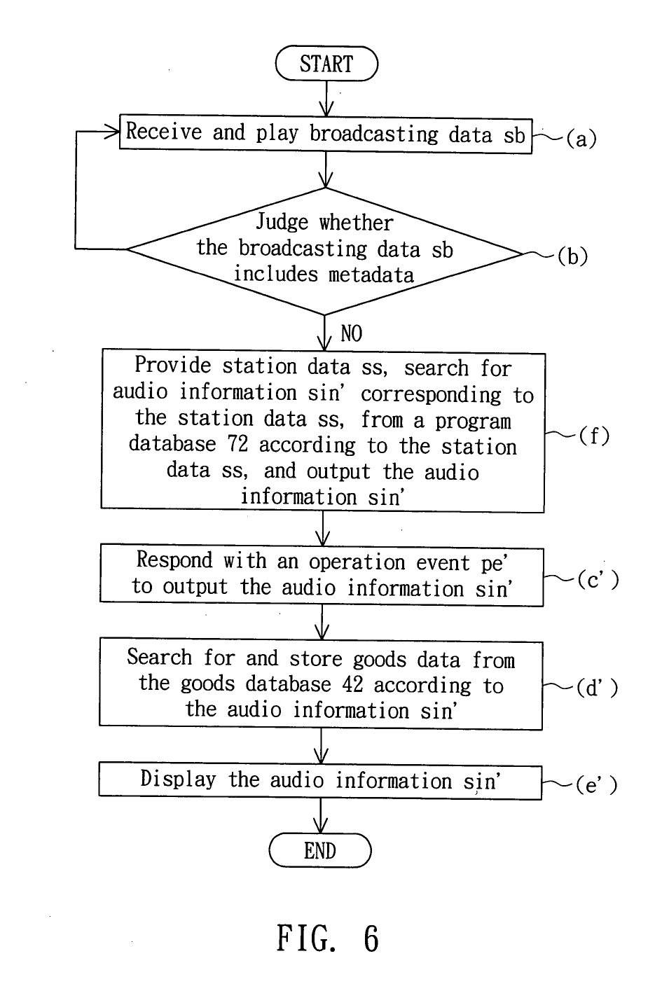

FIG. 6 is a flow chart showing a broadcasting data purchasing method according to the embodiment of the invention. As shown in FIG. 6, the difference between the broadcasting data purchasing methods of the first and second embodiments resides in the step (b), in which the media receiver 30 judges that the broadcasting data Sb does not include the metadata M and then the step (f) is performed. In the step (f), the media receiver 30′ provides the station data Ss to the program data server 70, and searches for and outputs the audio information Sin′ corresponding to the station data Ss from the program database 72 according to the station data ss.

Then, the steps (c′) and (d′) substantially similar to the steps (c) and (d) of the first embodiment are performed in order to respond with a purchasing operation event pe′ to output the audio information Sin′ and in order to search for the goods data from a goods database 42′ according to the audio information Sin′. The method further includes, after the step (d′), the step (e′) in which the media receiver 30′ displays the audio information Sin′ in a display unit 38b′.

The communication link 80 of this embodiment may be, for example, a communication link using the hypertext transfer protocol as the application layer software stack, and the program data server 70 may have, for example, a communication unit corresponding to the network server.

In this embodiment, the program data server 70 is utilized to find out the audio information Sin′ and the audio information Sin′ is outputted to the online shopping server 40′ through the media receiver 30′ so that the corresponding goods data can be found. However, the invention is not limited thereto. The program data server 70 of this embodiment may also directly output the audio information Sin′ to the online shopping server 40′ to search for the goods information corresponding thereto.

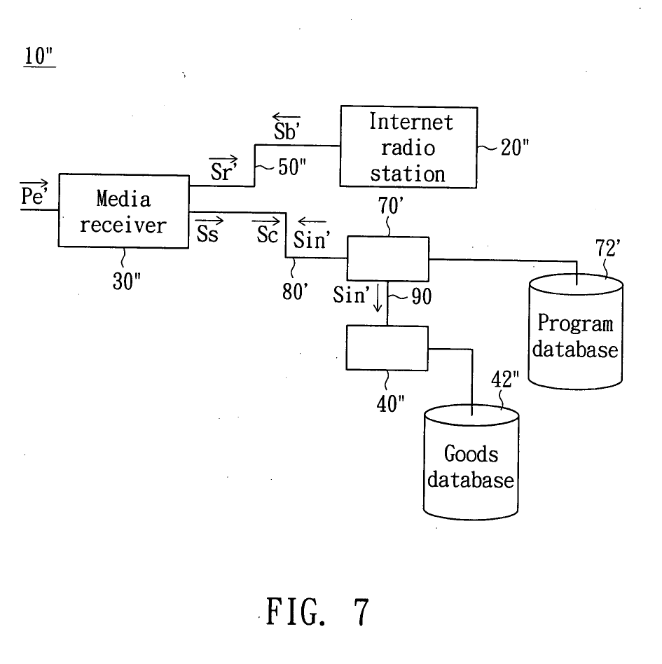

FIG. 7 is a block diagram showing another broadcasting data purchasing system 10″ according to the embodiment of the invention. As shown in FIG. 7, a communication link 90 for connecting a program data server 70′ to an online shopping server 40″ is provided. When a media receiver 30″ detects that the purchasing operation event pe′ is triggered, the media receiver 30″ generates a control signal Sc and outputs the control signal Sc to the program data server 70′ to drive the program data server 70′ to output the audio information Sin′ to the online shopping server 40″.

The broadcasting data purchasing system and the method thereof of this embodiment utilize the media receiver, which can find out the corresponding audio information and the corresponding goods data respectively from the program data server and the shopping server according to the network address of the network radio station. Thus, the broadcasting data purchasing system and the method thereof according to this embodiment may also effectively improve the drawback that the conventional media receiver cannot effectively provide the convenient broadcasting data purchasing channel. Thus, the invention substantially has the advantage of providing the convenient broadcasting data purchasing channel for the user.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A broadcasting data purchasing system, comprising:
an internet radio station for providing broadcasting data;
a media receiver for receiving and playing the broadcasting data, and judging whether the broadcasting data comprises metadata, wherein the metadata comprises first audio information relevant to the broadcasting data, and the media receiver responds with an operation event to output the first audio information when the broadcasting data comprises the metadata; and
an online shopping server, which comprises a goods database, receives the first audio information, searches for goods data from the goods database according to the first audio information, and stores the goods data.

2. The system according to claim 1, further comprising:
a program data server comprising a program database, wherein when the broadcasting data does not comprise the metadata, the media receiver outputs station data relevant to the internet radio station to the program data server so as to search for second audio information corresponding to the broadcasting data from the program database according to the station data and output the second audio information.

3. The system according to claim 2, wherein the media receiver receives and displays the second audio information, the media receiver further responds with the operation event to perform one of an operation of providing the second audio information to the online shopping server and an operation of driving the program data server to provide the second audio information to the online shopping server so as to search for and store the shopping record.

4. The system according to claim 1, wherein the media receiver further comprises:
a communication unit, which is connected to the internet radio station and the online shopping server for receiving the broadcasting data and outputting the first audio information;
a multimedia processor for receiving and playing the broadcasting data;
a processor for judging whether the broadcasting data comprises the metadata, wherein when the broadcasting data comprises the metadata, the processor generates the first audio information according to the metadata and responds with a driving signal to output the first audio information through the communication unit; and
a user interface unit for displaying the first audio information and responding with the operation event to generate the driving signal.

5. The system according to claim 4, wherein:
when the broadcasting data does not comprise the metadata, the processor generates station data relevant to the internet radio station and outputs the station data through the communication unit; and
the broadcasting data purchasing system comprises a program data server, which comprises a program database for searching for second audio information corresponding to the broadcasting data from the program database according to the station data and outputs the second audio information.

6. The system according to claim 5, wherein the user interface unit receives and displays the second audio information through the communication unit, the processor responds with the driving signal to perform one of an operation of outputting the second audio information to the online shopping server through the communication unit and an operation of driving the program data server to output the second audio information to the online shopping server so as to search for and store the goods data.

7. The system according to claim 4, wherein:
the media receiver further comprises a radio unit for receiving and playing analog broadcasting data, and further outputting a receiving frequency corresponding to the analog broadcasting data; and
the user interface unit further responds with a position operation event to generate position data.

8. The system according to claim 7, wherein:
the processor generates station data according to the receiving frequency and the position data; and
the broadcasting data purchasing system comprises a program data server comprising a program database, and searches for second audio information corresponding to the broadcasting data from the program database and outputting the second audio information according to the station data.

9. The system according to claim 8, wherein the user interface unit receives and displays the second audio information through the communication unit, the processor responds with the driving signal to perform one of an operation of outputting the second audio information to the online shopping server through the communication unit and an operation of driving the program data server to output the second audio information to the online shopping server so as to search for and store the goods data.

10. A broadcasting data purchasing method, comprising the steps of:
(a) receiving and playing broadcasting data;
(b) judging whether the broadcasting data comprises metadata, wherein the metadata comprises first audio information relevant to the broadcasting data, and performing step (c) if the broadcasting data comprises the metadata;
(c) responding with an operation event to output the first audio information; and
(d) searching for goods data from a goods database according to the first audio information and storing the goods data; and
(e) displaying the first audio information.

11. The method according to claim 10, wherein the step (b) further comprises the step of:
performing step (f) of providing station data to a program database and searching for second audio information corresponding to the station data from the program database according to the station data and outputting the second audio information when the broadcasting data does not comprise the metadata.

12. The method according to claim 11, further comprising, after the step (f) the steps of:
(c′) responding with an operation event to output the second audio information; and
(d′) searching for the goods data from the goods database according to the second audio information and storing the goods data.
